(19) United States
(12) Patent Application Publication
(10) Pub. No.: US 2005/0137970 A1
(43) Pub. Date: Jun. 23, 2005

(54) Method and apparatus for intercepting purchase data and awarding random purchase rebates in retail stores

(75) Inventors: Pascal-Simon Houle, St-Romuald (CA); Jerome Chapdelaine, Quebec (CA); Dominique M. Champagne, St-Jean-Chrysostome (CA); Francois Lefebvre, St-Jean-Chrysostome (CA); Marcel Huard, St-Romuald (CA); Real Berube, St-Jean-Chrysostome (CA); Marcel Lachance, Saint-Bernard (CA)

Correspondence Address: OGILVY RENAULT, 1981 MCGILL COLLEGE AVENUE, SUITE 1600, MONTREAL, QC, H3A2Y3, CA

(73) Assignee: DEQ Systemes Corp.

(21) Appl. No.: 11/052,880

(22) Filed: Feb. 9, 2005

Related U.S. Application Data
(63) Continuation of application No. PCT/CA03/01273, filed on Aug. 21, 2003.

(51) Int. Cl. G06F 17/60

(52) U.S. Cl. 705/39

(57) ABSTRACT

A method and a system for awarding an instant rebate are provided. The method comprises: determining a price for each item of a purchase of at least one item made by a client; selecting at least one item of the purchase using the nature of the item, the price determined, a price for a plurality of item and/or a total price for the purchase; activating a random rebate generator using the item selected to determine if an amount proportional to the price determined is to be awarded to the client; calculating an altered price by reducing the price determined by the proportional amount if the proportional amount is to be awarded; carrying out a payment of the altered price by the client.

### CROSS-REFERENCE TO RELATED APPLICATIONS

This application claims priority under 35USC§119(e) of U.S. provisional patent application Ser. No. 60/404,759 filed on Aug. 21, 2002 and this application is a continuation of PCT patent application serial number PCT/CA03/01273 filed on Aug. 21, 2003, designating the United States and now pending, the specifications of which are hereby incorporated by reference.

### TECHNICAL FIELD

The invention relates to awarding purchase rebates. More specifically, it relates to intercepting data between a point-of-sale device and its peripherals to award random purchase rebates proportional to a purchase amount to buyers who are purchasing items.

### BACKGROUND OF THE INVENTION

Retail store owners are always looking for ways to attract new customers and to keep current customers coming into their store. Unless the store has a high level of revenues, publicities in newspapers, on television and on radio are quite expensive for the immeasurable effect that they have.

Retail store owners have therefore looked for other means of attracting customers. Because human beings are always very happy to be awarded something, many prior art systems have been created in which prizes and points are awarded to customers.

Some retail store chains, such as Canadian Tire and The Bay in Canada have decided to create a “scratch-and-save” ™ sale. These sales occur at specific dates within the year. Each customer coming into the store is handed a card bearing a square to be scratched to uncover a rebate which will be applicable on the purchase price of the items he then decides to purchase. Typically, the squares cannot be scratched by the customer prior to the purchase transaction being about to be completed at the cash register. The cashier then scratches the square and confirms the amount of the rebate with the customer. Rebates in percentages are typically offered. The customer may then decide to follow through with the purchase, to remove items or to cancel his purchase. Once the purchase is completed, the cashier initials the card and the customer can continue to make purchases using the initialed card. However, if the customer decides to cancel his purchase, the cashier typically keeps the unused card. A rebate of 10% is typically the minimum rebate uncovered by scratching the square. Rebates of 50% can be, for example, printed on one card out of 833. The rebates are printed in advance on the cards and the customer is handed a pre-printed card as he enters the store. A predetermined quantity of each rebate is printed and the number of occurrences of each rebate is predetermined.

This system has the drawback, for the retail store owner, that if the rebate awarded by the card is not high enough according to the customer's expectations, the customer can walk away without making any purchase or without making the full purchase he had intended to.

A gas station chain, Esso, has created a frequent buyer program called Esso Extra™, which gives points for each purchase made by a member of the program. These points can then be used to obtain merchandise, such as gas, snacks, oil, car wash, etc. In addition to this program, Esso has introduced a series of contests where the customer may win a prize or an additional number of Esso Extra points. The prizes are instantaneous. Typically, the result of the draw is shown of the receipt for the qualifying purchase and lets the customer know right away if he won the contest prize or extra points.

This system has the drawback that the prizes awarded are points which the customers get tired of accumulating points at all different stores they shop at. The grand prizes can also seem unattainable to the customers. Customers also believe that it takes an enormous amount of points to obtain a reward and that they will forget to use the points because they need to be used at a much later time. Therefore, even though the prize is awarded instantaneously, the effects of the reward are not strong and the fidelity of the customer is not assured. Moreover, the client does not have an incentive to make a bigger purchase because of the program since the size of his purchase is unrelated to the prize potentially won in addition to the standard points.

### SUMMARY OF THE INVENTION

Accordingly, an object of the present invention is to overcome the drawbacks of the prior art systems.

In particular, an object of the present invention is to capture the data being communicated between a point-of-sale device and its peripherals. This data can then be used to award a purchase rebate proportional to the purchase price of the items purchased by the customer. The customer can then see a direct effect on the cost of the transaction he just concluded.

According to a broad aspect of the present invention, there is provided a method for awarding an instant rebate. The method comprises determining a purchase price for a purchase of at least one item made by a client; activating a random rebate generator when the purchase price is determined; randomly determining using the random rebate generator if an amount proportional to the purchase price is to be awarded to the client; reducing the purchase price by the proportional amount if the proportional amount is to be awarded.

According to another broad aspect of the present invention, there is provided a system for awarding an instant rebate. The system comprises a data gatherer for obtaining a purchase information about a purchase of at least one item; a random rebate generator triggered by the data gatherer to calculate a purchase price for the at least one item using the purchase information and to determine if an amount proportional to the purchase price is to be awarded to the client; a rebate calculator reducing the purchase price by the proportional amount if the proportional amount is determined to be awarded.

The item is preferably a fresh product.

According to still another broad aspect of the present invention, there is provided a method for awarding an instant rebate. The method comprises: determining a price for each item of a purchase of at least one item made by a client; selecting at least one item of the purchase using at least one of a nature of the item, the price determined, a price for a plurality of item and a total price for the purchase; activating a random rebate generator using the at least one item selected to determine if an amount proportional to the price determined is to be awarded to the client; calculating an altered price by reducing the price determined by the proportional amount if the proportional amount is to be awarded; carrying out a payment of the altered price by the client.

According to a further broad aspect of the present invention, there is provided a system for awarding an instant rebate. The system comprises: a data gatherer for obtaining purchase information about a purchase of at least one item made by a client; a price calculator for determining a price for each item of the purchase from the purchase information; an item selector for selecting at least one item of the purchase using at least one of a nature of the item, the price determined, a price for a plurality of the at least one item and a total price for the purchase; a random rebate generator triggered by the item selector to determine if an amount proportional to the item price for the at least one item chosen by the item selector is to be awarded to the client; a rebate calculator reducing the price by the proportional amount to obtain an altered price if the proportional amount is determined to be awarded; a payment receiver for carrying out a payment of the altered price.

A method and system for awarding an instant rebate are provided. The method comprises determining a purchase price for a purchase of at least one item made by a client; activating a random rebate generator when the purchase price is determined; randomly determining using the random rebate generator if an amount proportional to the purchase price is to be awarded to the client; reducing the purchase price by the proportional amount if the proportional amount is to be awarded. Preferably, the item is a fresh product.

A method and a system for awarding an instant rebate are provided. The method comprises: determining a price for each item of a purchase of at least one item made by a client; selecting at least one item of the purchase using the nature of the item, the price determined, a price for a plurality of item and/or a total price for the purchase; activating a random rebate generator using the item selected to determine if an amount proportional to the price determined is to be awarded to the client; calculating an altered price by reducing the price determined by the proportional amount if the proportional amount is to be awarded; carrying out a payment of the altered price by the client.

### BRIEF DESCRIPTION OF THE DRAWINGS

These and other features, aspects and advantages of the present invention will become better understood with regard to the following description and accompanying drawings wherein:

FIG. 1 is a flow chart of the main steps of the awarding of a rebate;

FIG. 2 is a block diagram of the main components of a first embodiment of the system for awarding a rebate;

FIG. 3 is a rebate attribution table for a return of 2%, with 300 customers;

FIG. 4 is a rebate attribution table for a return of 2%, with 500 customers;

FIG. 5A and FIG. 5B together are a rebate attribution table for a return of 2%, with 11450 customers receiving a rebate and 6 customers not receiving a rebate;

FIG. 6 is a rebate attribution table for a return of 1.48%, with 11405 customers;

FIG. 7 is a rebate attribution table for a return of 1.48%, with 11405 customers receiving a rebate and 5 customers not receiving a rebate;

FIG. 8 is a rebate attribution table for a return of 1.48%, with 200 customers receiving a rebate and 1000 customers not receiving a rebate;

FIG. 9 is a rebate attribution table for a return of 1%, with 16096 customers;

FIG. 10 is a rebate attribution table for a return of 9.5%, with 1200 customers;

FIG. 11 is a rebate attribution table for a return of 10.3%, with 10000 customers;

FIG. 12 is a rebate attribution table for a return of 5%, with 200 customers receiving a rebate and 85 customers not receiving a rebate;

FIG. 13 comprises FIG. 13A and FIG. 13B; FIG. 13 is a block diagram of the main components of a first portion of a second embodiment of the present invention; FIG. 13B is a block diagram of the main components of a second portion of the second embodiment of FIG. 13A;

FIG. 14 is a block diagram of the main components of the data gathering system;

FIG. 15 is a circuit diagram for the architecture of the micro circuit responsible for gathering the data;

FIG. 16 comprises FIG. 16A and FIG. 16B, FIG. 16A is a male connector for the PS/2 port, FIG. 16B is a female connector for the PS/2 port;

FIG. 17 is a circuit diagram for the architecture of a general open-collector interface;

FIG. 18 is a timing diagram for the device to host communication;

FIG. 19 is an example of a scan code for the “Q” key (15h) being sent from a keyboard to the computer, channel A is the clock signal, channel B is the data signal;

FIG. 20 is a timing diagram for the host to device communication;

FIG. 21 is a timing diagram for a detailed host to device communication;

FIG. 22 is the most frequently used standard scan code set for a keyboard;

FIG. 23 is an example of the make and break codes for a few keys;

FIG. 24 is a table showing the typematic repeat rate;

FIG. 25 is a table showing the typematic delay;

FIG. 26 is a table showing the argument byte; and

FIG. 27 is a flow chart of the main steps of the data gathering method.

It will be noted that throughout the appended drawings, like features are identified by like reference numerals.

### DETAILED DESCRIPTION OF THE PREFERRED EMBODIMENT

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

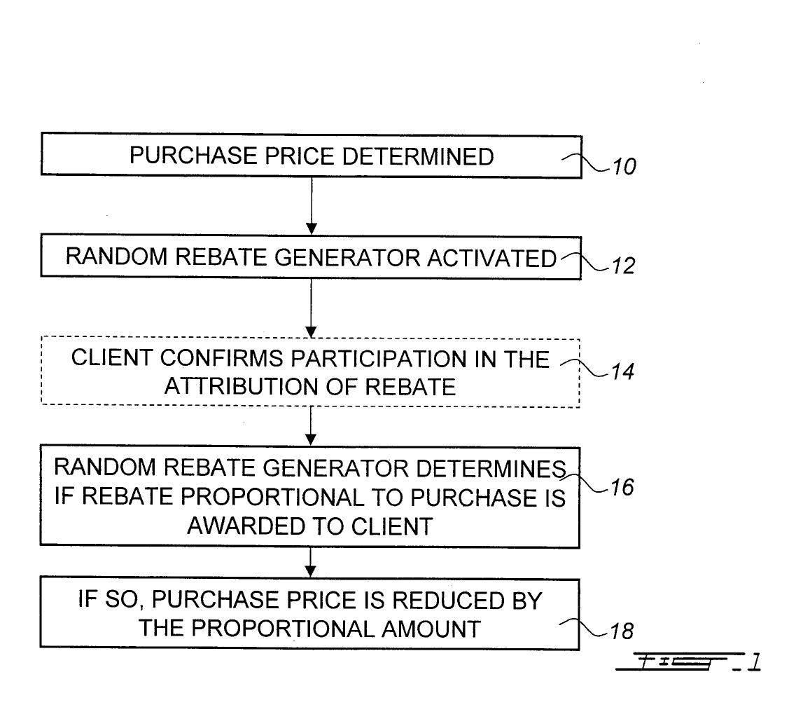

Referring now to FIG. 1, a preferred embodiment of the present invention will now be described. The first step of the method for awarding an instant rebate is that a client makes a purchase 10. This purchase comprises at least one item. The total amount of the purchase is calculated and amounts to a purchase price. The item can be a bag of fresh fruits, for example apples, which needs to be weighted and associated to a proper billing code before a purchase price is determined. The price of the item is determined. The purchase can then be completed or a simple sub-total can be calculated.

Completing the purchase involves receiving a payment from the customer to pay the purchase price. The payment can be made in cash, using a credit card, a debit card, a smart card, coupons, etc. When the payment is received or an authorization from the card issuer is received and the transaction is recorded, the transaction is considered to be completed. As soon as the sub-total identifying the purchase price is determined, a random rebate generator can be activated 12. The random rebate generator can be triggered by the reaching of the price for the item, for a plurality of items or a total on the cash register and an attribution of a mode of payment.

The random rebate generator randomly determines 16 if an rebate or reimbursement proportional to the purchase price is to be awarded to the client. The random rebate generator is programmed to award rebates according to a predetermined rebate attribution table, for example, one in one hundred. When the random rebate generator is activated, it randomly decides whether this activation is the one in one hundred rebate attributing activation.

If the random rebate generator determines that this activation is rebate attributing, the purchase price is reduced by the proportional amount 18. If the total was already paid, the reimbursement can be carried out using the same means as the payment was made with or by any other means. If the payment is not yet received for the purchase, the proportional amount is attributed as a rebate on the purchase price.

Preferably, the proportional amount or percentage attributed can be printed by a ticket printer on a ticket using text or a barcode. If the ticket printer prints a barcode, the barcode can then be read by the optical reader of the cash register to directly calculate the reimbursement or rebate to be given to the customer.

Preferably, the proportional amount is the full purchase price, the client therefore receiving a complete reimbursement or rebate for his purchase. This has an immediate positive effect on the client and on the other customers waiting in line at the cash registers. The client then leaves the store with his items without having paid anything.

As will be understood, in the case the rebate attributed is the full purchase price, the more expensive the average purchase price per customer is, the lesser chances of being attributed the rebate should be used in order to ensure that the retail store owner does not lose more than a predetermined percentage of his revenues to this incentive.

Preferably, the retail store owner calculates an average purchase price per customer at his store and determines an acceptable portion of his revenues that he is willing to assign to this incentive. Once both of these variables are obtained, the odds are calculated and programmed in the random rebate generator.

Some retail store owners may prefer to give only a percentage less than 100% of the purchase price as a rebate. Again the odds can be calculated for the specific needs of the retail store owner and the random rebate generator can be programmed accordingly.

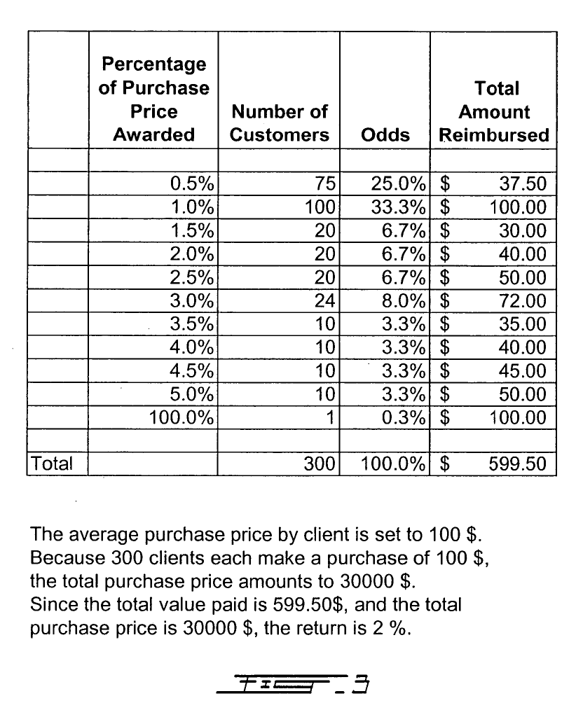

Examples of rebate attribution tables are provided in FIGS. 3 to 12. These are examples of payout probabilities that can be programmed in the random rebate generator to yield an average return chosen by the store owner. For the purposes of illustrating the return, the average purchase price of the customers was set to 100 $. As will be understood, this average purchase price could be set to any amount. The rebate attribution table would still show the same return. As will also be understood, not all customers will buy items amounting to the average purchase price, this will therefore influence the return rate in the short term. Also, since the determination of the customers receiving a rebate is done randomly, there may be variations in the return in the short term. However, in the long run, the return programmed within the random rebate generator will be respected.

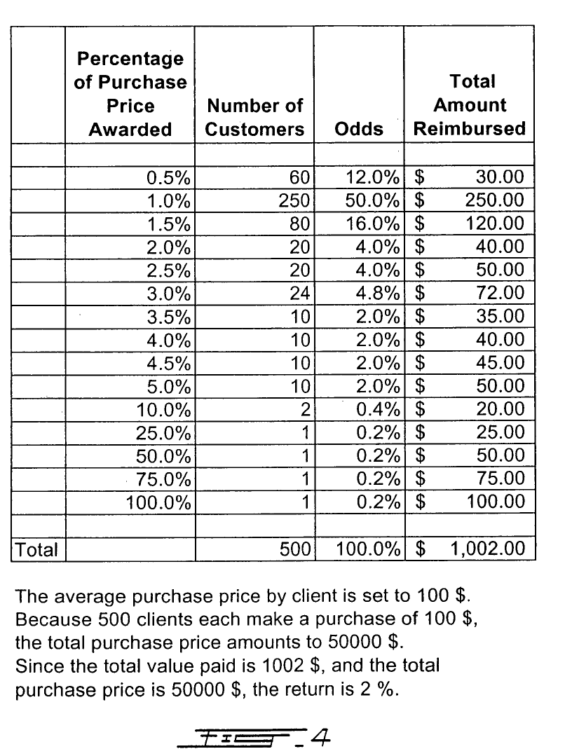

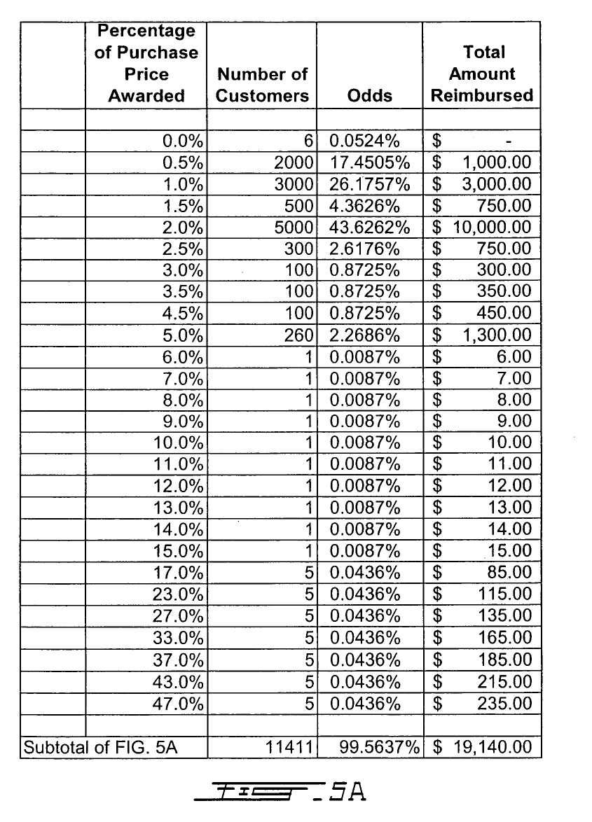

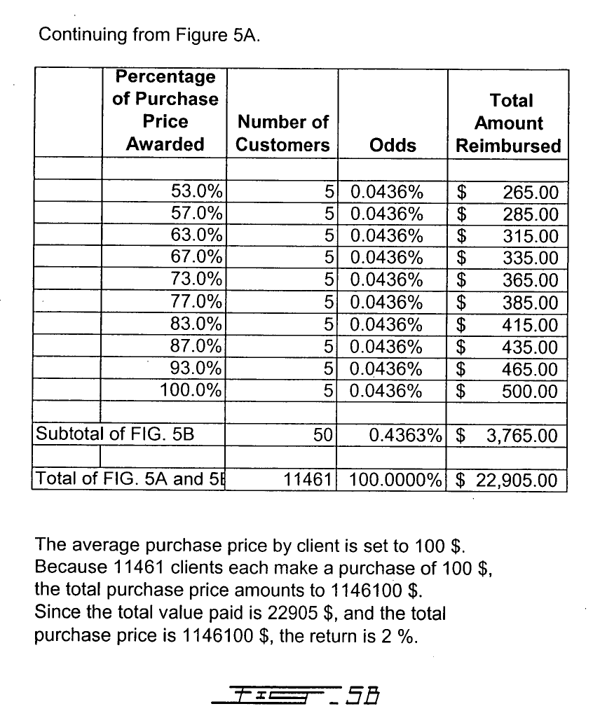

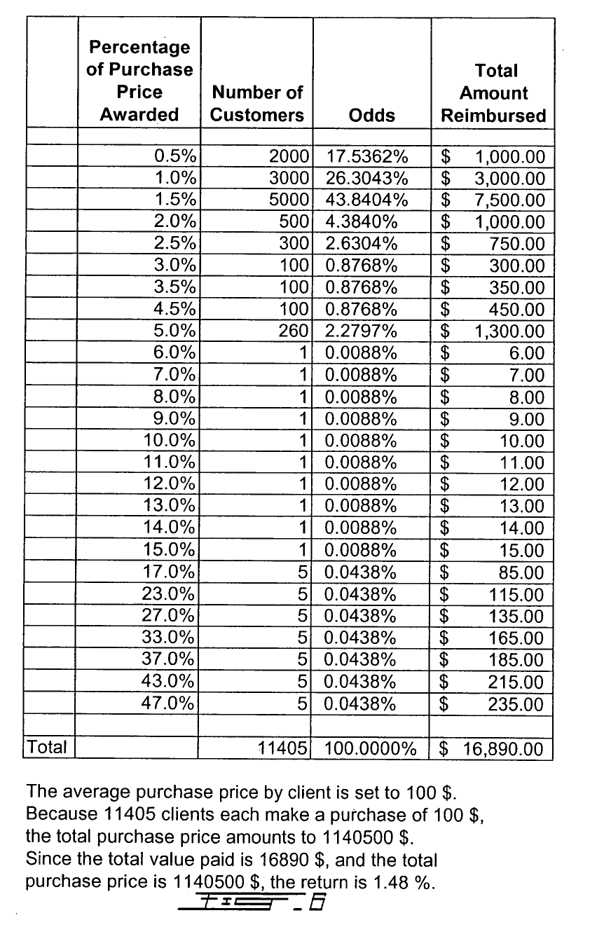

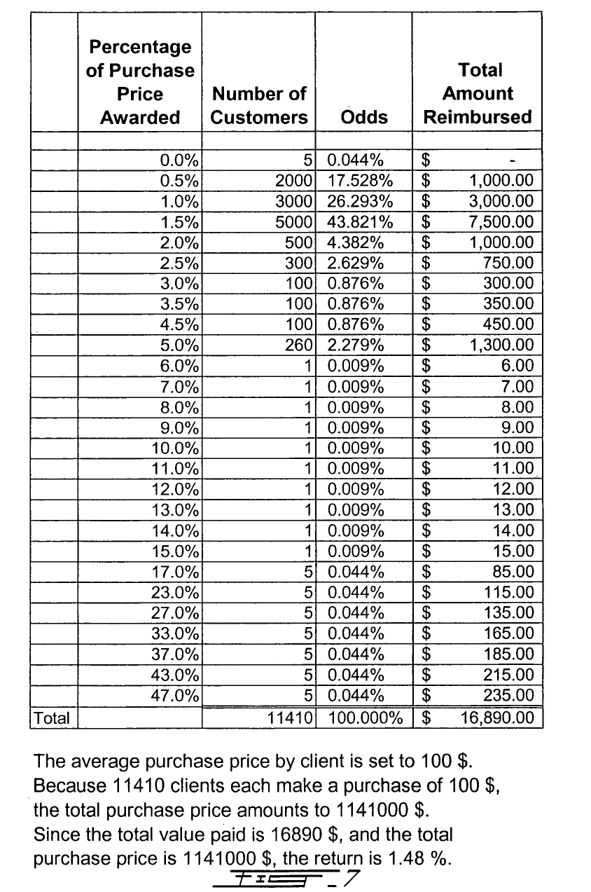

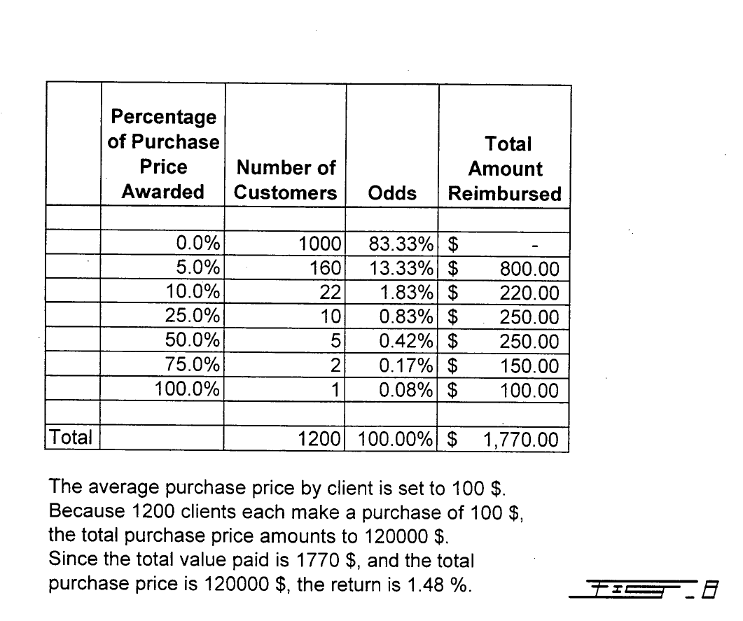

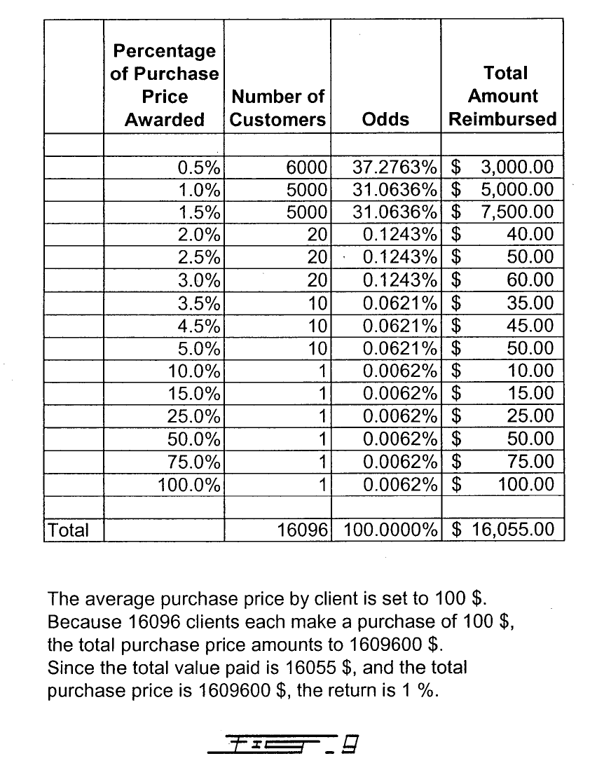

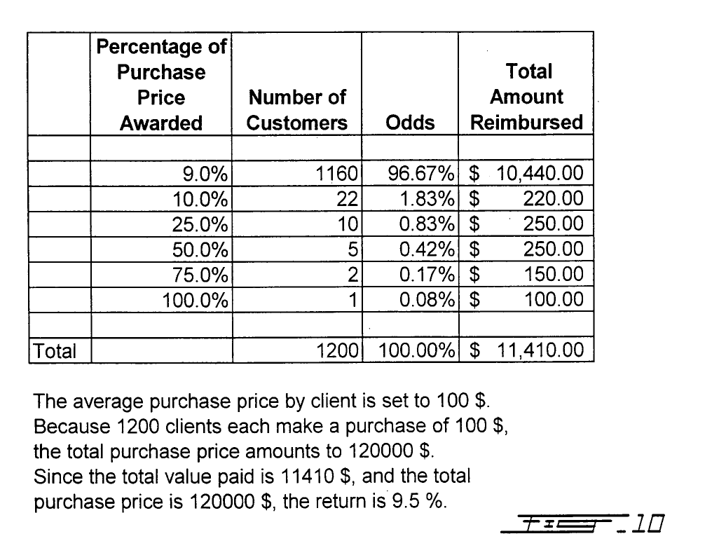

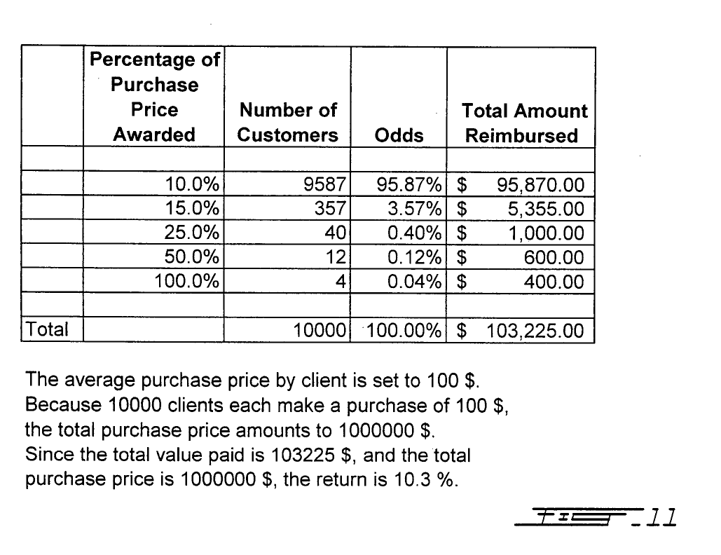

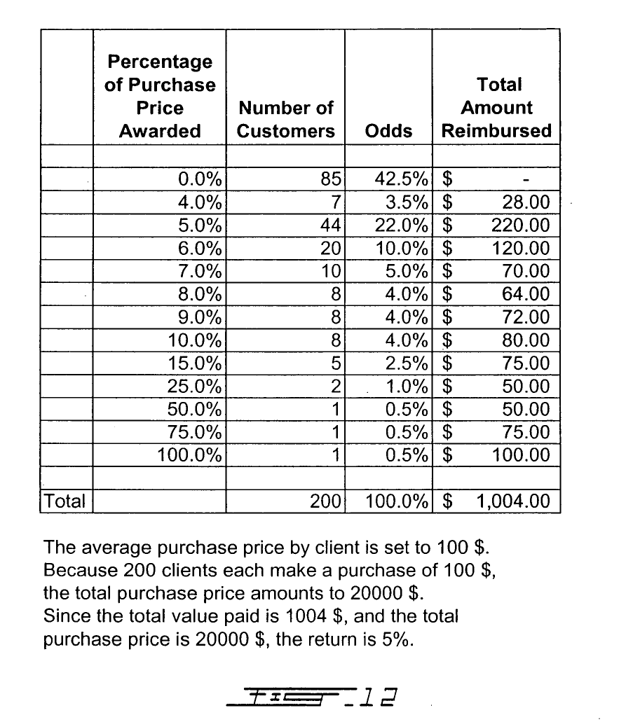

FIGS. 3 to 12 are rebate attribution table examples showing different reimbursement or rebate and return schemes. It will be understood that a rebate attribution table for any return rate with a number of customers receiving a rebate and customers not receiving a rebate could be built and used by the system. FIG. 3 is a rebate attribution table for a return of 2%, with 300 customers receiving a rebate; FIG. 4 is a rebate attribution table for a return of 2%, with 500 customers receiving a rebate; FIG. 5A and FIG. 5B together are a rebate attribution table for a return of 2%, with 11450 customers receiving a rebate and 6 customers not receiving a rebate; FIG. 6 is a rebate attribution table for a return of 1.48%, with 11405 customers receiving a rebate; FIG. 7 is a rebate attribution table for a return of 1.48%, with 11405 customers receiving a rebate and 5 customers not receiving a rebate; FIG. 8 is a rebate attribution table for a return of 1.48%, with 200 customers receiving a rebate and 1000 customers not receiving a rebate; FIG. 9 is a rebate attribution table for a return of 1%, with 16096 customers receiving a rebate; FIG. 10 is a rebate attribution table for a return of 9.5%, with 1200 customers receiving a rebate; FIG. 11 is a rebate attribution table for a return of 10.3%, with 10000 customers receiving a rebate; FIG. 12 is a rebate attribution table for a return of 5%, with 200 customers receiving a rebate and 85 customers not receiving a rebate.

The rebate attribution tables can be built to ensure that a minimum percentage of the purchase price will always be awarded to the customer. Examples of such tables are found in FIGS. 3, 4, 6, 9, 10 and 11. Other rebate attribution tables can have customers not receiving a rebate, that is customers who are awarded a reimbursement or rebate of 0%.

It will be understood that the random rebate generator may be programmed with a plurality of rebate attribution tables to allow flexibility of the system. For example, one store owner may decide to have three rebate attribution tables depending on the day the purchase is made. The first rebate attribution table would give a return of 1% and would be the one typically used. A second rebate attribution table with a return of 2% would be used on special days advertised by the store owner or an third party. A third rebate attribution table would guarantee that each client receives at least a reimbursement or rebate of 10%, while maintaining a return of 1% and would be used on weekends. It will be understood that any combination of rebate attribution tables could be used to suit the store owners' needs.

Preferably, the system is provided by a third party which rents the random rebate generators. This third party can then manage the publicity of the system by advertising the list of stores which offer such a chance to be awarded a reimbursement or rebate of purchases. This third party can also decide to publish the list of recent customers who have been awarded large amounts. This third party publicity can be done in parallel with the store owner's own publicity efforts.

This method could be used in conjunction with traditional publicity means such as ads in local newspapers where the total number of customers who have received a rebate could be indicated or the names of the last customers who have received a rebate could be printed. For example, the last ten customers who have received a rebate could be displayed.

Sales taxes are common in industrialized countries. A retail store owner may decide to reimburse the full purchase price including taxes to the customer and absorb the tax amount or may decide to only give back the amount corresponding to the purchase price before taxes. The customer therefore receives almost 100% of his purchase price, less the percentage amount corresponding to taxes in that particular state and country.

The method can comprise a further optional step of the client confirming 14 his participation in the random attribution of the rebate. This confirmation can be done using a slap button placed on the counter where items are placed to be purchased. The client would then slap the button after the purchase price is determined. This would trigger the random rebate generator to carry out the attribution of the rebate. This step involves the participation of the client and makes him believe the moment he chooses to press the participation recorder has an effect on the attribution of the rebate.

The confirmation could include requesting an answer to a skills testing question, the answer of which would be used to confirm the awarding of the rebate in states where legislation requires a correct answer to such a question to be awarded the rebate.

Displaying the outcome of the random attribution of the rebate to the customer is also preferred to show him that the cashier is not trying to prevent him from getting his rebate. This also attracts the attention of the other customers and generates interest for the system.

Once the rebate is awarded, the cashier preferably records the name of the client having received the rebate, displays it on a small screen near the cash register and arranges for a special message to be displayed on a bigger screen in the store. This message reminds customers that it is possible to be awarded at least a portion of your purchase in this particular store and can generate even more interest if a customer recognizes a name from the message display.

A sound can also be generated when the customer receives a rebate or not. Another sound can also be played while the random rebate generator determines the result of the attribution of the rebate. The rebate attribution sound may be a recorded voice saying: “Your purchase is free! Please ask the cashier for your rebate!” These all increase customers' interest.

The random rebate generator does not have to be connected to the cash registers. In order to install this system more rapidly and easily, the cashier may be responsible to manually activate the random rebate generator and manually enter in the cash register the result of the attribution of the rebate. In these cases however, it would be preferable that a synchronization methodology be used to track which purchases yielded reimbursements or rebates. This synchronization methodology may be the time and date of the purchase, the bill number, the signature of the client on both transactions, etc.

In addition or alternatively to receiving a proportional amount of the purchase price, the customer could be given a chance in a random draw among all customers who have received a rebate in that day, week, month or year. The amount awarded in that additional draw would typically be much greater than the average purchase price. The tickets to participate in this draw could be printed directly from the ticket printer. The ticket printer can be triggered by the random rebate generator. If necessary, a keyboard can be provided to enter the name and telephone number of the customer who will participate in the additional draw.

A customer fidelity program could be used in conjunction with this system. A customer, member of the customer fidelity program, could be awarded two chances of receiving the purchase amount or may have access to a different rebate attribution table. This privileged customer may also get a chance of receiving a multiple of the percentage received in the first attribution of the rebate. The store owner may decide to limit the amount reimbursed or remitted to the customer to 100%. Because this privileged customer has taken the time to register in the customer fidelity program, special promotions may only be accessible to him. For example, a profile of his purchases can be built and offers can be proposed to him depending on this profile and can yield even better odds in the random attribution of the rebate.

The customer who is a member of the fidelity program may receive a fidelity card. This fidelity card confirms that he has access to the special fidelity program. If such a card is provided to the privileged customers, a participation recorder can have a card reader able to receive the fidelity card and retrieve information about the customer from the card's memory. This would then identify the client and, in case the client receives a rebate, would accelerate the process of obtaining his identification. This fidelity card could be assigned a personal identification number (PIN) to be entered in the participation recorder to ensure that the proper person is using the fidelity card. A PIN attribution device could then be provided with the system to allow customers to choose and program their own PIN into the fidelity card. This fidelity card could be combined with an existing credit or debit card if such a card can be further programmed.

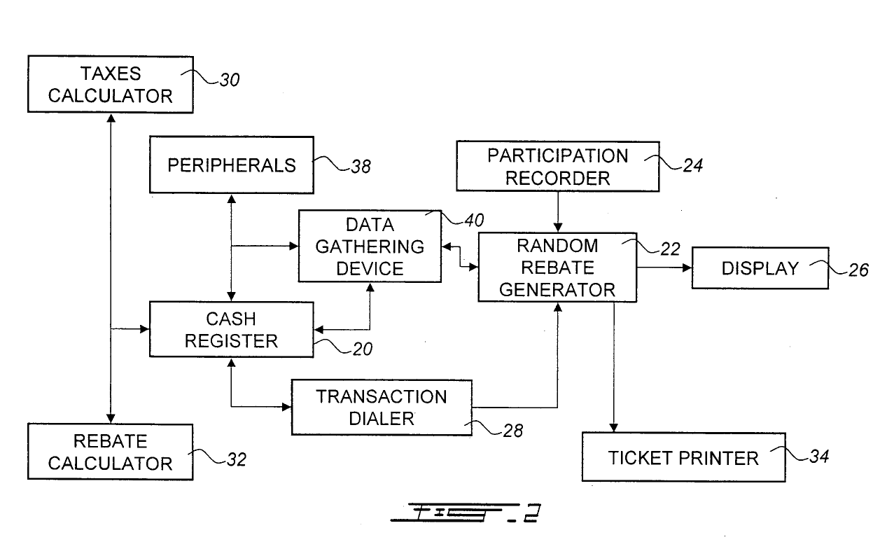

Referring now to FIG. 2, the main components of the present invention will be described. The system for awarding an instant rebate comprises a cash register or point-of-sale device 20 for completing a purchase of at least one item for a purchase price. The cash register 20 has peripherals 38 such as a keyboard, a barcode scanner, a scale, a screen, a printer, etc. A data gathering device 40 intercepts data communicated between the cash register 20 and its peripherals 38 to determine the item being purchased and its purchase price. The data intercepted is then directly sent back to the cash register 20 or further processed by the random rebate generator 22 before being sent back to the cash register 20. A random rebate generator 22 receives a signal confirming that a purchase price has been determined (an item price was determined, a sub-total was reached or the purchase was completed) from the data gathering device 40 and determines if an amount proportional to the purchase price is to be awarded to the client. The cash register 20 is then used to complete a reimbursement or rebate of the proportional amount to the client if the proportional amount is determined to be awarded.

Preferably, a client participation recorder 24 is used to confirm that the client making the purchase wishes to participate in a attribution of the rebate by the random rebate generator 22.

The system can further include a transaction dialer 28 for contacting a card issuer when a client making the purchase is paying the purchase price using a credit or a debit card, the random rebate generator 22 is then activated either by the transaction dialer once the transaction with the card issuer is completed or by the cash register 20 when the authorization is received through the transaction dialer 28.

A display 26 for displaying a result of the attribution of the rebate adds to the interest of the system for the customers.

The cash register 20 preferably uses a rebate calculator 32 to determine the amount to be reimbursed or remitted, especially if the rebate amount is less than 100% of the purchase price. The rebate calculator 32 receives the percentage determined by the random rebate generator 22 and receives the purchase price from the cash register 20. It then calculates the appropriate reimbursement or rebate amount to be reimbursed or remitted to the client. A sales tax calculator 30 may also be needed if sales taxes are not to be reimbursed or remitted to the client because of local regulations.

Depending on the implementation, the rebate and taxes calculators 32, 30 can communicate directly with the random rebate generator 22 so that the information sent back to the cash register 20 already includes the appropriate rebate.

A ticket printer 34 is preferably provided and is triggered by the random rebate generator 22 to print a confirmation of the result of the attribution of the rebate. This confirmation can include the percentage of the purchase amount to be reimbursed or remitted. A keyboard 38 is also preferably provided to enter the name and telephone number of the customer into the ticket printer 34 so that the confirmation ticket printed includes such an identification of the customer who received a rebate. This may be necessary in countries where the names of customers who have received a rebate of more than a certain amount in a random attribution of the rebate must be declared to a public authority.

It will be understood that the system of the present invention could be networked within the store, throughout the chain of stores of a particular brand, or throughout a specific region of a chain of stores of a particular brand. The display of the last customers who have received a rebate could be generic to the complete network or personalized for a particular portion of the network. Some elements of the system could be networked while others would be independent.

Another embodiment of the invention could take on the aspect of an add-on to a credit or debit transaction apparatus. The apparatus would include the following: a transaction recorder for recording a purchase by a client of at least one item for a purchase price, a transaction dialer for contacting a card issuer when the client is paying the purchase price using a credit or a debit card, a random rebate generator receiving a signal either from the transaction recorder or the transaction dialer and determining if an amount proportional to the purchase price is to be awarded to the client. In this embodiment the present invention is fully realized using software and is implemented directly into an Interac™ or other credit or debit transaction apparatus.

In that embodiment, the transaction recorder records a reimbursement or rebate transaction of the proportional amount to the client if the proportional amount is determined to be awarded and the transaction dialer completes the reimbursement or rebate transaction with the card issuer.

The client participation recorder for confirming that a client making the purchase wishes to participate in an attribution of the rebate by the random rebate generator can simply be entering into the apparatus a personal identification number (PIN) assigned to the card or pushing an “OK” button on the apparatus.

Preferably, the display used in that embodiment is the same display as the one used to complete the credit or debit transaction.

In another embodiment, a specific purchase may entitle a customer to access a different rebate attribution table with better odds. For example, a store owner may identify a product in the store, for example, peanut butter of a certain brand in a grocery store, which will trigger the use of an alternative rebate attribution table by the random rebate generator. The fact that the client has purchased the specific product may be manually confirmed by the cashier or, using the data gathering device, the random rebate generator can determine from the product identification code if the specific product has been purchased and then use the appropriate rebate attribution table.

Similarly, different rebate attribution tables can be used depending on the profile of the customer. For example, senior citizens having proper identification may have access to a higher-rebate attribution table on certain days of the week.

In still another embodiment of the present invention, the invention could take on the form of a fully integrated add-on in a standard cash register, such as a cash register manufactured by NCR. The apparatus would include the same elements. In this embodiment, the present invention is fully realized using software and is implemented directly into a NCR cash register.

In that embodiment, the display used is the customer display of the cash register and the ticket printer if provided, is the receipt printer.

In a further embodiment of the present invention, illustrated in FIG. 13A, the cash register 20 can be connected to a ticket printer 38. This ticket printer 38, which may be the standard receipt printer of the cash register, can print a ticket which mentions the purchase price. The purchase price can be written on the ticket or may be represented by a barcode. For example, the purchase price before taxes can be $24.95 and the ticket printer can print a ticket mentioning this amount using a barcode.

Irregardless of whether the ticket printed is the same as the receipt typically given to the customer, the customer may then go to a rebate awarding station shown in FIG. 13B, with the ticket. The rebate awarding station has a ticket reader 42. The ticket reader 42 may read the purchase price from the ticket. If the purchase price is coded in a barcode, the ticket reader 42 is a barcode reader. Preferably, the ticket bears a date and/or time which can be used to determine the validity of the ticket by the validity checker 48. For example, the ticket may only be valid for a period of 20 minutes following the purchase, or can be valid for a period of two weeks following the purchase.

If the ticket is valid, and preferably following an action by the customer to be done using the participation recorder 24, the random rebate generator 22 then determines if a reimbursement or rebate is to be awarded to the customer. If such a reimbursement or rebate is to be given, it is preferably displayed by the display 44. The random rebate generator 22 can then be connected to a validated ticket printer 46 which prints the percentage of the purchase price awarded to the customer on the original ticket or on a new ticket. This ensures that the percentage awarded by the system may not be altered by a cashier or a customer with poor ethics. The validated ticket can then be taken to a cash register assigned to the rebate awarding station or any other cash register for a reimbursement or rebate of the proportional amount. The validated ticket can also be kept by the customer for use in a future purchase in the store. The validated ticket can be assigned a duration for use.

Preferably, the ticket reader 42 and the validated ticket printer 46 are provided in a single apparatus which receives the ticket, retrieves the information from it, requests validation by the validity checker 48 and receives the signal with information on the rebate attributed. It then prints the proportional amount or percentage attributed directly on the same ticket and ejects it.

Preferably, the proportional amount or percentage printed by the validated ticket printer 46 has the form of a barcode which can then be read by the optical reader of the cash register to directly calculate the reimbursement or rebate to be given to the customer.

This embodiment allows a single rebate awarding station to be used in conjunction with a plurality of cash registers in a particular store or in one location for a plurality of stores.

It therefore does not delay handling of the purchase at the cash register. Customers who wish to participate in the random attribution of the rebate simply have to walk to the rebate awarding station in order to receive their validated ticket.

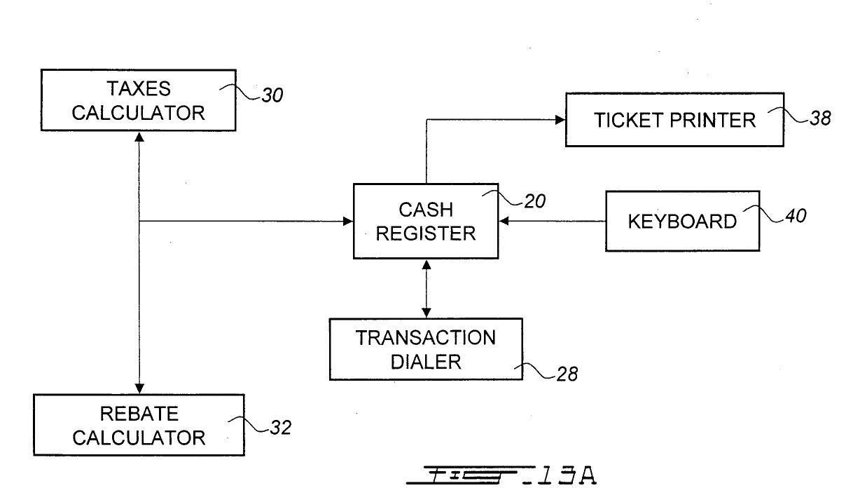

Shown in FIG. 14 is the data gathering system. The Data Gathering Device 40, DGD, is placed between the computer in a Point-Of-Sale system (the cash register 20), POS, and its peripherals 38 such as keyboard 52, scale 54 and bar code scanner 56 to intercept the data and redirect it to an external computer, the random rebate generator 22 (RRG), for analysis before it is allowed through to the POS 20 in its original or in a somewhat altered form. This way, not only can the DGD 40 allow the RRG 22 to know all the details of a transaction being performed at the POS 20, but it allows the RRG 22 to track and to act on this data and perform some related function and/or alter the data before it is re-injected for processing by the POS 20.

The DGD 40 is preferably made up of nine serial ports, one universal serial bus (USB) port, and one custom keyboard interface plus some additional circuitry for power supply regulation and general interface purposes.

The use of the serial ports is as follows. Six of the nine available serial ports are paired into Data-In/Data-Out pairs each dedicated to a particular peripheral, in this instance, a bar code scanner, a weight scale and a random rebate generator peripheral. The seventh port is dedicated to the communication between the DGD 40 and the RRG 22. Finally, the remaining two serial ports are general purpose serial ports reserved for future uses.

The USB port is not in use in this implementation of the circuitry but will be useful in the future when more elaborate and more time intensive tasks are required from the system such as higher speed communication with the RRG 22 because of higher data load to be transferred or as more “intelligent” peripherals that therefore require higher bandwidth are introduced in the POS environment.

Finally, the keyboard interface is used in the same manner as the serial ports, that is, so as to allow the RRG 22 to monitor and possibly take action depending on the nature of the information being input into the POS. All data from the peripherals are redirected by the DGD 40 to the RRG 22 for tracking and analysis.

The DGD 40 comprises a microcontroller, uC 70, programmed to poll the various input ports and report any and all activity to the RRG 22 for processing. Furthermore, the uC 70 is responsible for the interpretation and tagging of the information transmitted to the RRG 22.

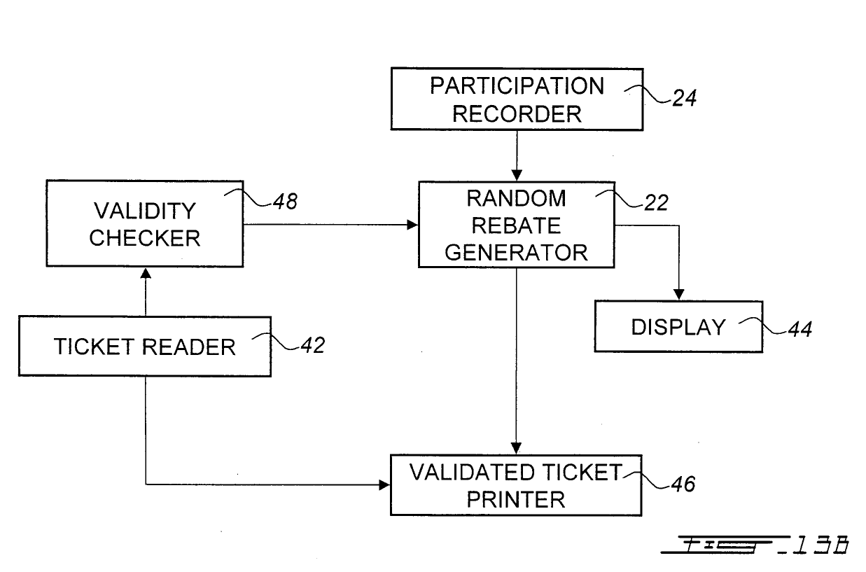

When the uC detects data present at a particular port, it initiates the transfer of this data into its buffer and starts the re-transmission procedure to the RRG 22. Once the RRG 22 has received the data it can act upon it and instruct the uC to let the data through or to transmit the altered data that the RRG 22 sends the uC. The architecture of the uC circuit 70 is illustrated in FIG. 15.

### DETAILED DESCRIPTION OF THE HARDWARE

The function of each of the principal elements of the DGD circuit will be explained.

The PIC 18F452-AN

The microcontroller used in this embodiment of the DGD is a member of Microchip's PIC18FXX2 series of high performance RISK microcontrollers. The particular device used is the PIC18F452-AN microcontroller 70. These devices come in 40/44-pin packages. A pin by pin function description of the inputs and outputs (I/O) and other connections used on the device will be given. It is not the intent nor the purpose of this text to give an introductory tutorial in the use and programming of microcontrollers and more specifically of these devices. For further information on the matter and the internal hardware and software workings of the PIC18FXX2 family, the reader is referred to Microchip's DS39564B Datasheet document that describes the inner workings of the microcontrollers in this family.

Pin 1:

The MCLR/VPP pin is the Master Clear (input) or high voltage ICSP programming enable pin. It is held high to indicate that the device is not to reset and to enable its programming.

Pin 2:

This pin is a general input/output pin of Port A of the device. It is used here to generate the reset signal for all the other DGD system peripherals at the beginning of the execution of the programmed instructions.

Pins 33-40:

These pins are part of Port B of the device and are used by the DGD system as the I/O interface to the keyboard. Specifically Pins 33, 34, 35 and 36 are outputs to the keyboard and the other pins are inputs to the microcontroller from the keyboard.

Pins 10 and 15-18 and Pins 23-24:

These are I/O pins that belong to the Port C of the device and are used here as an address bus to select and access individual areas/capabilities of the DGD hardware. Of course, it should be clear to the reader that these pins could also be used as address pins with any other DGD peripherals that could be interfaced to it.

Pins 25-26:

These are I/O pins that belong to the Port C of the device and are used here as the receive input and transmit output from the microcontroller to the serial port dedicated to the communication with the RRG 22.

Pins 19-22 and Pins 27-30:

These are I/O pins that belong to the Port D of the device and are used here as a internal data bus for the input and output of information to and from the microcontroller and the DGD's peripheral devices.

Pins 8-9:

These are I/O pins that belong to the Port E of the device and are used here as control signals for the I/O operations to and from the microcontroller to the peripherals that are part of the serial port and USB port sub-system of the DGD. Here again, it should be clear to the reader that these pins could also be used as read and write signals with any other DGD peripherals that could be interfaced to it. Pin 8 is a general write signal and pin 9 is a general read signal.

Pin 13:

Pin 13 is a clock input to the microcontroller and is self-explanatory.

The DS14C232:

The DS14C232 is a low power dual driver/receiver featuring an onboard DC to DC converter, eliminating the need for ±12V power supplies. The device only requires a +5V power supply. The driver's slew rate are set internally and the receivers feature internal noise filtering, eliminating the need for external slew rate and filter capacitors. The device is designed to interface data terminal equipment (DTE) with data circuit-terminating equipment (DCE). The driver inputs and receiver outputs are TTL and CMOS compatible. DS14C232C driver outputs and receiver inputs meet TIA/EIA-232-E (RS-232) and CCITT V.28 standards.

VCC (Pin 16)

Power supply pin for the device, +5V (±10%).

V+ (Pin 2)

Positive supply for TIA/EIA-232-E drivers. An external capacitor of 1.0 μF (6.3V) is used as a power reserve. A capacitor of value larger than 1 μF may be used. This supply is not intended to be loaded externally.

V− (Pin 6)

Negative supply for TIA/EIA-232-E drivers. An external capacitor of 1.0 μF (6.3V) is used as a power reserve. A capacitor of value larger than 1 μF may be used. This supply is not intended to be loaded externally.

C1+, C1− (Pins 1, 3)

External capacitor connection pins used by the internal charge pump to generate the TIA/EIA-232-E levels. A capacitor of 10 μF is used here.

C2+, C2− (Pins 4, 5)

External capacitor connection pins used by the internal charge pump to generate the TIA/EIA-232-E levels. A capacitor of 10 μF is used here.

DIN 1, DIN 2 (Pins 11, 10)

Driver input pins are TTL/CMOS compatible. These pins connect the microcontroller and/or its peripherals and/or RRG 22's transmit, Tx, pins.

DOUT 1, DOUT 2 (Pins 14, 7)

Driver output pins conform to TIA/EIA-232-E levels. These pins connect the microcontroller and/or its peripherals and/or RRG 22's receive, Rx, pins.

RIN 1, RIN 2 (Pins 13, 8)

Receiver input pins accept TIA/EIA-232-E input voltages (±25V). Receivers possess a noise filter and guaranteed hysteresis of 100 mV.

ROUT 1, ROUT 2 (Pins 12, 9)

Receiver output pins are TTL/CMOS compatible.

GND (Pin 15)

Ground Pin.

TL16C554 Asynchronous Communications Element:

The TL16C554 is an enhanced quadruple versions of the TL16C550B asynchronous communications element (ACE). Each channel performs serial-to-parallel conversion on data characters received from peripheral devices and parallel-to-serial conversion on data characters transmitted by the CPU, in this case the POS and/or RRG 22. The complete status of each channel of the quadruple ACE can be read at any time during functional operation by the RRG 22. The information obtained includes the type and condition of the operation performed and any error conditions encountered. The TL16C554 quadruple ACE can be placed in an alternate first-in first-out (FIFO) mode, which activates the internal FIFOs to allow 16 bytes (plus three bits of error data per byte in the receiver FIFO) to be stored in both receive and transmit modes. To minimize system overhead and maximize system efficiency, all logic is on the chip. Two terminal functions allow signaling of direct memory access (DMA) transfers. We will now describe the function of each of the pins in use in this design.

Pins 32-34:

Register select terminals. A0, A1, and A2 are three inputs used during read and write operations to select the ACE register to read or write.

Pins 16, 20, 50 and 54:

Chip select signals CSA, CSB, CSC and CSD. Each chip select (CSx) enables read and write operations to its respective channel.

Pins 17, 19, 51 and 53:

Transmit outputs signals TXA, TXB TXC, TXD. TXx is a composite serial data output that is connected to a communications device. TXA, TXB, TXC, and TXD are set to the marking (high) state as a result of reset.

Pins 7, 29, 41 and 63:

Serial input signals RXA, RXB, RXC and RXD. RXx is a serial data input from a connected communications device. During loop back mode, the RXx input is disabled from external connection and connected to the TXx output internally.

Pin 52:

Read strobe IOR. A low level on IOR transfers the contents of the TL16C554 data bus to the external system bus.

Pin 18:

Write strobe IOW. IOW allows the CPU to write into the selected address by the address register.

Pin 37:

Master reset. When active, RESET clears most ACE registers and sets the state of various signals.

The transmitter output and the receiver input is disabled during reset time.

Pin 35:

External clock input. An external clock can be connected to drive the internal clock circuits.

Pins 1-5 and 66-68:

I/O Data bus D7-D0. Eight data lines with 3-state outputs provide a bidirectional path for data, control, and status information between the TL16C554 and the microcontroller. D0 is the least significant bit (LSB).

USBN9603/USBN9604 Universal Serial Bus Full Speed Node Controller:

This device will be of use in the near future when higher speed peripherals and more complex data need to be sent by the DGD to the RRG 22 for processing. As an example of a future system that would require such high speed communication one may think of an automated check out counter where some and even all item being checked out by a customer would be identified by a computer vision system and then input to the POS computer for tabulation. Such a system would require a tremendous amount of data to flow between the RRG 22 and the POS and would therefore require a much faster interface.

The device is a Universal Serial Bus (USB) Specification, 1.0 and 1.1. It integrates onto a single IC the required USB transceiver with a 3.3V regulator, the Serial Interface Engine (SIE), USB endpoint FIFOs, a versatile (eight-bit parallel or serial) interface and a clock generator. A total of seven endpoint pipes are supported: one bidirectional for the mandatory control EPO and an additional six for unidirectional endpoints to support USB interrupt, bulk and isochronous data transfers. The 8-bit parallel interface supports multiplexed and non-multiplexed style CPU address/data buses. The synchronous serial MICROWIRE interface allows adapting to CPUs without external address/data buses. A programmable interrupt output scheme allows adapting to different interrupt signaling requirements.

The device contains a high-speed transceiver which consists of three main functional blocks: differential receiver, single-ended receiver with on-chip voltage reference and transmitter with on-chip current source.

This transceiver meets the performance requirements described in Chapter 7 of the USB Specification, Version 1.1. To minimize signal skew, the differential output swings of the transmitter are well balanced. Slew-rate control is used on the driver to minimize radiated noise and crosstalk. The drivers support TRI-STATE operation to allow bidirectional, half-duplex operation of the transceiver.

The differential receiver operates over the complete common mode range, and has a delay guaranteed to be larger than that of the single-ended receivers. This avoids potential glitches in the Serial Interface Engine (SIE) after single-ended zeros. Single-ended receivers are present on each of the two data lines. These are required, in addition to the differential receiver, to detect an absolute voltage with a switching threshold between 0.8V and 2.0V (TTL inputs). To increase Vcc rejection, without glitching, a voltage reference sets the single-ended switching reference. An external 1.5±5% K resistor is required on D+ to indicate that this is a high-speed node. This resistor should be tied to a voltage source between 3.0V and 3.6V, and referenced to the local ground, such as the output provided on pin V3.3.

The voltage regulator provides 3.3V for the integrated transceiver from 5.0V device power or USB bus power. This output can be used to supply power to the 1.5 K pull-up resistor. This output must be decoupled with a 1 μF tantalum capacitor to ground. It can be disabled under software control to allow using the device in a 3.3V system.

The SIE is comprised of physical (PHY) and Media Access Controller (MAC) modules. The PHY module includes the digital-clock recovery circuit, a digital glitch filter, End Of Packet (EOP) detection circuitry, and bit stuffing and unstuffing logic. The MAC module includes packet formatting, CRC generation and checking, and endpoint address detection. It provides the necessary control to give the NAK, ACK and STALL responses as determined by the Endpoint Pipe Controller (EPC) for the specified endpoint pipe. The SIE is also responsible for detecting and reporting USB-specific events, such as NodeReset, NodeSuspend and NodeResume. The module output signals to the transceiver are well matched (under 1 nsec) to minimize skew on the USB signals.

The USB specifications assign bit stuffing and unstuffing as the method to ensure adequate electrical transitions on the line to enable clock recovery at the receiving end. The bit stuffing block ensures that whenever a string of consecutive 1's is encountered, a 0 is inserted after every sixth 1 in the data stream. The bit unstuffing logic reverses this process.

The clock recovery block uses the incoming NRZI data to extract a data clock (12 MHz) from a 48 MHz input clock. This input clock is derived from a 24 MHz oscillator in conjunction with PLL circuitry (clock doubler). This clock is used in the data recovery circuit. The output of this block is binary data (decoded from the NRZI stream) which can be appropriately sampled using the extracted 12 MHz clock. The jitter performance and timing characteristics meet the requirements set forth in Chapter 7 of the USB Specification.

The ERRG provides the interface for USB function ultimate source or sink of data. An endpoint pipe facilitates the movement of data between USB and memory, and completes the path between the USB RRG 22 and the function endpoint. According to the USB specification, up to 31 such endpoints are supported at any given time. USB allows a total of 16 unidirectional endpoints for receive and 16 for transmit. As the control endpoint 0 is always bidirectional, the total number is 31. Seven endpoint pipes with the same function address are supported.

A USB function is a USB device that is able to transmit and receive information on the bus. A function may have one or more configurations, each of which defines the interfaces that make up the device. Each interface, in turn, is composed of one or more endpoints.

Each endpoint is an addressable entity on USB and is required to respond to IN and OUT tokens from the USB RRG 22 (typically a RRG). IN tokens indicate that the RRG 22 has requested to receive information from an endpoint, and OUT tokens indicate that it is about to send information to an endpoint.

On detection of an IN token addressed to an endpoint, the endpoint pipe should respond with a data packet. If the endpoint pipe is currently stalled, a STALL handshake packet is sent under software control. If the endpoint pipe is enabled but no data is present, a NAK (Negative Acknowledgment) handshake packet is sent automatically. If the end point pipe is isochronous and enabled but no data is present, a bit stuff error followed by an end of packet is sent on the bus. Similarly, on detection of an OUT token addressed to an endpoint, the endpoint pipe should receive a data packet sent by the RRG 22 and load it into the appropriate FIFO. If the endpoint pipe is stalled, a STALL handshake packet is sent. If the end-point pipe is enabled but no buffer is present for data storage, a NAK handshake packet is sent. If the endpoint is isochronous and enabled but cannot handle the data, no handshake packet is sent.

A disabled endpoint does not respond to IN, OUT, or SETUP tokens. The ERRG maintains separate status and control information for each endpoint pipe. For IN tokens, the ERRG transfers data from the associated FIFO to the RRG 22. For OUT tokens, the ERRG transfers data in the opposite direction.

The parallel interface is the mode of interface that was selected for these purposes. This allows the device to function as a CPU or microcontroller peripheral. This interface type and its addressing mode (multiplexed or non-multiplexed) is determined via device input pins MODE0 and MODE1. Non-multiplexed mode uses the control pins CS, RD, WR, the address pin A0 and the bidirectional data bus D7-0 as shown in This mode is selected by tying both the MODE1 and MODE0 pins to GND.

The CPU has direct access to the DATA_IN, DATA_OUT and ADDR registers. Reading and writing data to the device can be done either in standard access or burst mode.

Keyboard Interface Hardware and Protocol:

This section describes the interface used by the PS/2 keyboard. It will cover the physical and electrical interface, as well as the protocol.

The Physical Interface:

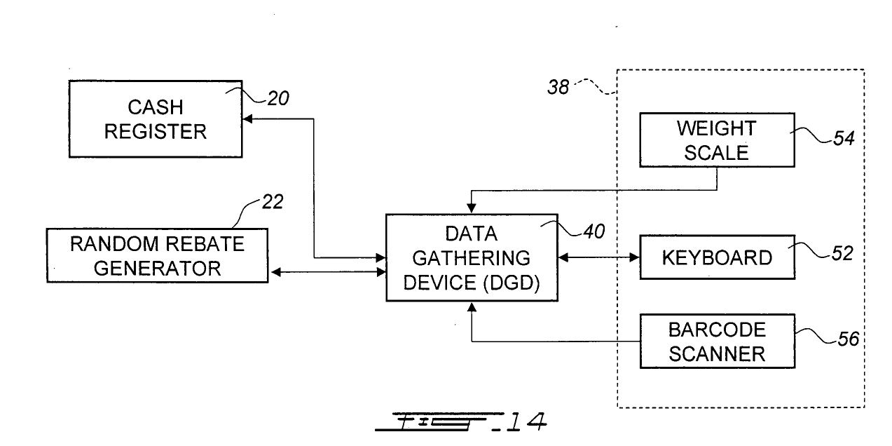

The physical PS/2 port is one of two styles of connectors: The five-pin DIN or the six-pin mini-DIN. In this case, the six-pin connector was used and is illustrated in FIGS. 16A and 16B.

The pins of the six-pin Mini-DIN are as follows:

Data

Not Implemented

Ground

Vcc (+5V)

Clock

Not Implemented

The Electrical Interface:

Vcc/Ground provide power to the keyboard. The keyboard should not draw more than 100 mA from the RRG 22 and care must be taken to avoid transient surges. Such surges can be caused by “hot-plugging” a keyboard (i.e., connect/disconnect the device while the computer power is on.)

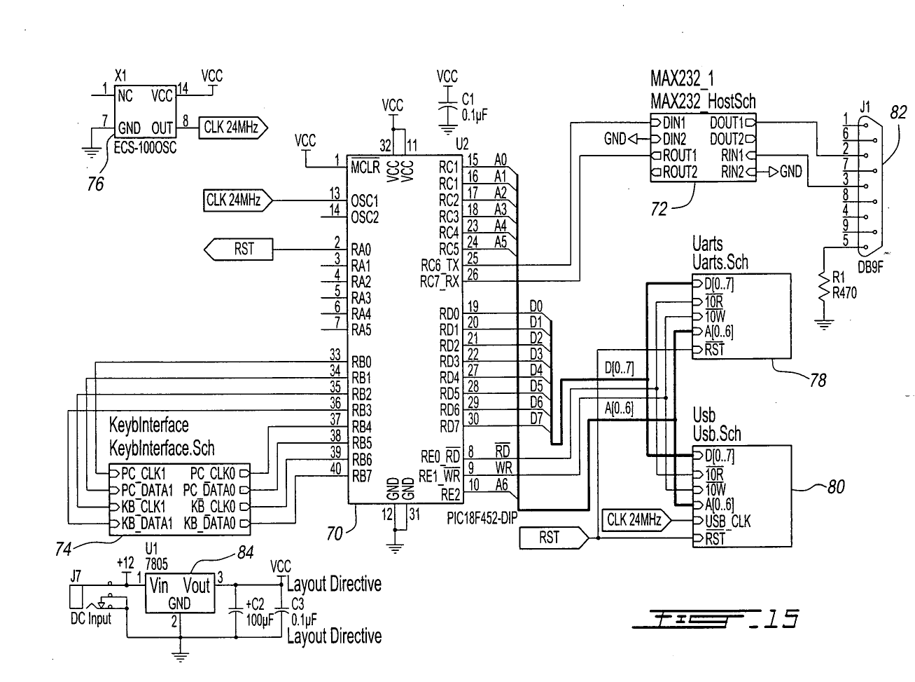

The Data and Clock lines are both open-collector with pull-up resistors to +5V. An “open-collector” interface has two possible state: low, or high impedance. In the “low” state, a transistor pulls the line to ground level. In the “high impedance” state, the interface acts as an open circuit and doesn't drive the line low or high. Furthermore, a “pull-up” resistor is connected between the bus and Vcc so the bus is pulled high if none of the devices on the bus are actively pulling it low. The exact value of this resistor isn't too important (1˜10 k Ohms); larger resistances result in less power consumption and smaller resistances result in a faster rise time. A general open-collector interface is shown in FIG. 17.

Communication: General Description

The PS/2 keyboard implements a bidirectional synchronous serial protocol. The bus is “idle” when both lines are high (open-collector). This is the only state where the keyboard/mouse is allowed to begin transmitting data. The RRG 22 has ultimate control over the bus and may inhibit communication at any time by pulling the Clock line low.

The device always generates the clock signal. If the RRG 22 wants to send data, it must first inhibit communication from the device by pulling Clock low. The RRG 22 then pulls Data low and releases Clock. This is the “Request-to-Send” state and signals the device to start generating clock pulses. The following table lists the bus states:

Summary: Bus States
Data = high, Clock = high: Idle state.
Data = high, Clock = low: Communication Inhibited.
Data = low, Clock = high: RRG 22 Request-to-Send

All data is transmitted one byte at a time and each byte is sent in a frame consisting of 11-12 bits. These bits are:

One start bit. This is always 0.
Eight data bits, least significant bit first.
One parity bit (odd parity).
One stop bit. This is always 1.
One acknowledge bit (RRG 22-to-device communication only)

The parity bit is set if there is an even number of 1's in the data bits and reset (0) if there is an odd number of 1's in the data bits. The number of 1's in the data bits plus the parity bit always add up to an odd number (odd parity.) This is used for error detection. The keyboard must check this bit and if incorrect it should respond as if it had received an invalid command.

Data sent from the device to the RRG 22 is read on the falling edge of the clock signal; data sent from the RRG 22 to the device is read on the rising edge. The clock frequency must be in the range 10-16.7 kHz. This means clock must be high for 30-50 microseconds and low for 30-50 microseconds. Timing is crucial in order to properly communicate the data.

Communication: Device-to-RRG 22

The Data and Clock lines are both open collector. A resistor is connected between each line and +5V, so the idle state of the bus is high. When the keyboard or mouse wants to send information, it first checks the Clock line to make sure it is at a high logic level. If it isn't, the RRG 22 is inhibiting communication and the device must buffer any to-be-sent data until the RRG 22 releases Clock. The Clock line must be continuously high for at least 50 microseconds before the device can begin to transmit its data.

As mentioned in the previous section, the keyboard and mouse use a serial protocol with 11-bit frames. These bits are:

One start bit. This is always 0.
Eight data bits, least significant bit first.
One parity bit (odd parity).
One stop bit. This is always 1.

The keyboard writes a bit on the Data line when Clock is high, and it is read by the RRG 22 when Clock is low.

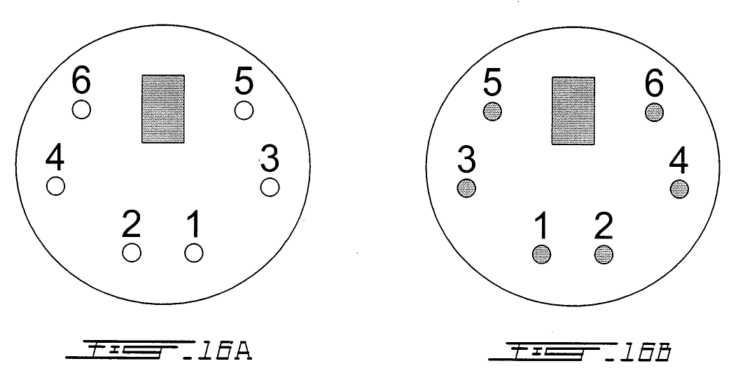

FIG. 18 is a timing diagram for the Device-to-host communication. The Data line changes state when Clock is high and that data is valid when Clock is low.

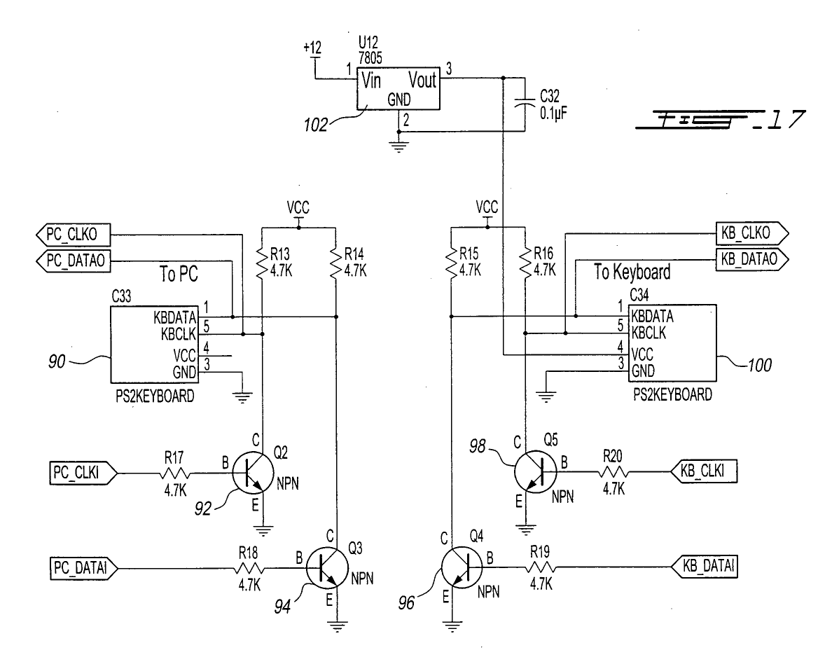

FIG. 19 is an example of a scan code for the “Q” key (15h) being sent from a keyboard to the computer. Channel A is the Clock signal; channel B is the Data signal.

The clock frequency is 10-16.7 kHz. The time from the rising edge of a clock pulse to a Data transition must be at least 5 microseconds. The time from a data transition to the falling edge of a clock pulse must be at least 5 microseconds and no greater than 25 microseconds.

The RRG 22 may inhibit communication at any time by pulling the Clock line low for at least 100 microseconds. If a transmission is inhibited before the 11th clock pulse, the device must abort the current transmission and prepare to retransmit the current “chunk” of data when RRG 22 releases Clock. A “chunk” of data could be a make code, break code, device ID, mouse movement packet, etc. For example, if a keyboard is interrupted while sending the second byte of a two-byte break code, it will need to retransmit both bytes of that break code, not just the one that was interrupted.

If the RRG 22 pulls clock low before the first high-to-low clock transition, or after the falling edge of the last clock pulse, the keyboard does not need to retransmit any data. However, if new data is created that needs to be transmitted, it will have to be buffered until the RRG 22 releases Clock. Keyboards have a 16-byte buffer for this purpose. If more than 16 bytes worth of keystrokes occur, further keystrokes will be ignored until there's room in the buffer.

Host-to-Device Communication:

The PS/2 device always generates the clock signal. If the RRG 22 wants to send data, it must first put the Clock and Data lines in a “Request-to-send” state as follows:

Inhibit communication by pulling Clock low for at least 100 microseconds.
Apply “Request-to-send” by pulling Data low, then release Clock.

The device should check for this state at intervals not to exceed 10 milliseconds. When the device detects this state, it will begin generating Clock signals and clock in eight data bits and one stop bit. The RRG 22 changes the Data line only when the Clock line is low, and data is read by the device when Clock is high. This is opposite of what occurs in device-to-host communication.

After the stop bit is received, the device will acknowledge the received byte by bringing the Data line low and generating one last clock pulse. If the RRG 22 does not release the Data line after the 11th clock pulse, the device will continue to generate clock pulses until the Data line is released (the device will then generate an error.)

The RRG 22 may abort transmission at time before the 11th clock pulse (acknowledge bit) by holding Clock low for at least 100 microseconds.

The steps the RRG 22 must follow to send data to a PS/2 device are as follows:

| | |
|---|---|
| 1) | Bring the Clock line low for at least 100 microseconds. |
| 2) | Bring the Data line low. |
| 3) | Release the Clock line. |
| 4) | Wait for the device to bring the Clock line low. |
| 5) | Set/reset the Data line to send the first data bit |
| 6) | Wait for the device to bring Clock high. |
| 7) | Wait for the device to bring Clock low. |
| 8) | Repeat steps 5-7 for the other seven data |
| | bits and the parity bit |
| 9) | Release the Data line. |
| 10) | Wait for the device to bring Data low. |
| 11) | Wait for the device to bring Clock low. |
| 12) | Wait for the device to release Data and Clock |

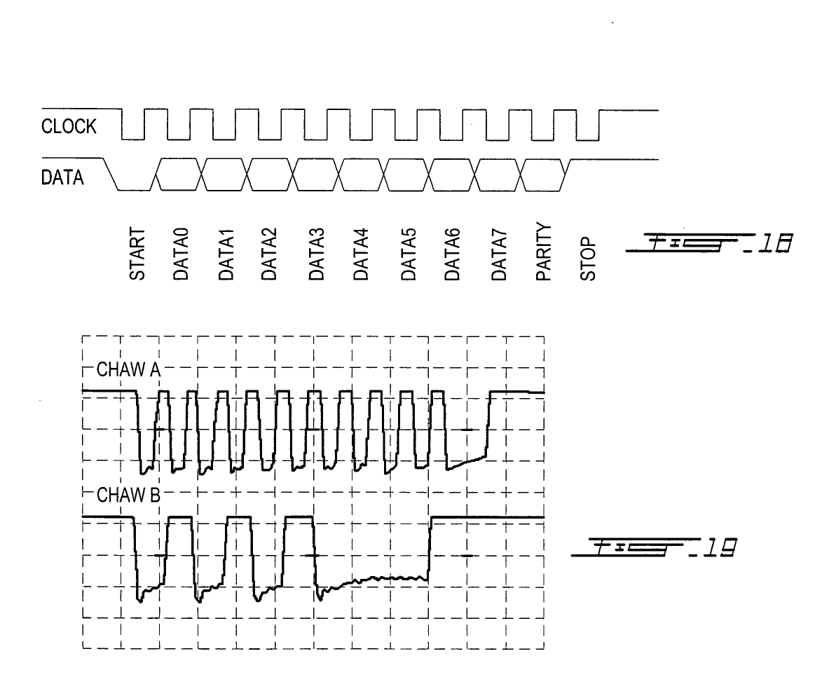

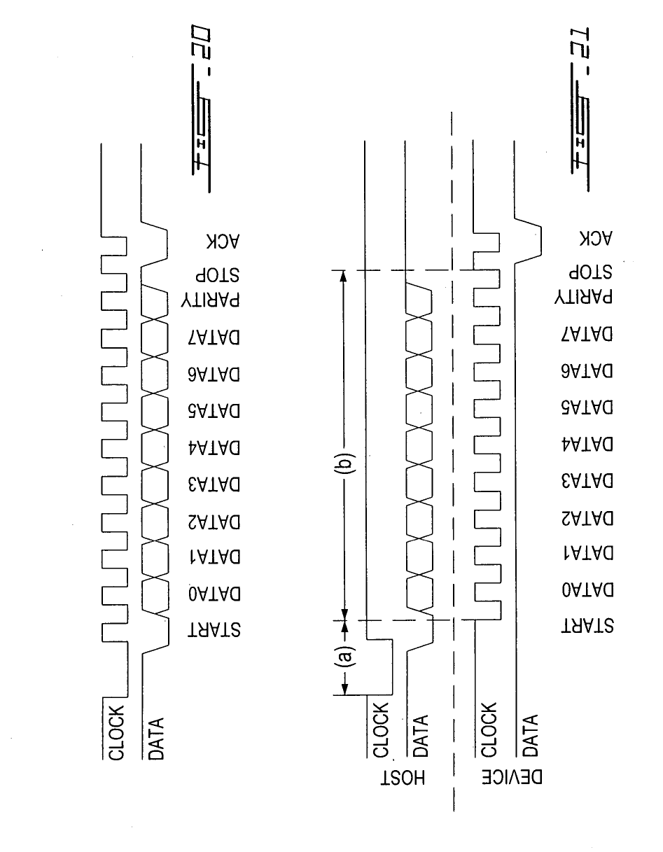

FIG. 20 shows this graphically and FIG. 21 separates the timing to show which signals are generated by the RRG 22, and which are generated by the PS/2 device. Notice the change in timing for the “ack” bit—the data transition occurs when the Clock line is high (rather than when it is low as is the case for the other 11 bits.)

Referring to FIG. 21, there are two time quantities the RRG 22 looks for: (a) the time it takes the device to begin generating clock pulses after the RRG 22 initially takes the Clock line low, which must be no greater than 15 ms; (b) the time it takes for the packet to be sent, which must be no greater than 2 ms. If either of these time limits is not met, the RRG 22 should generate an error. Immediately after the “ack” is received, the RRG 22 may bring the Clock line low to inhibit communication while it processes data. If the command sent by the RRG 22 requires a response, that response must be received no later than 20 ms after the RRG 22 releases the Clock line. If this does not happen, the RRG 22 generates an error.

Scan Codes:

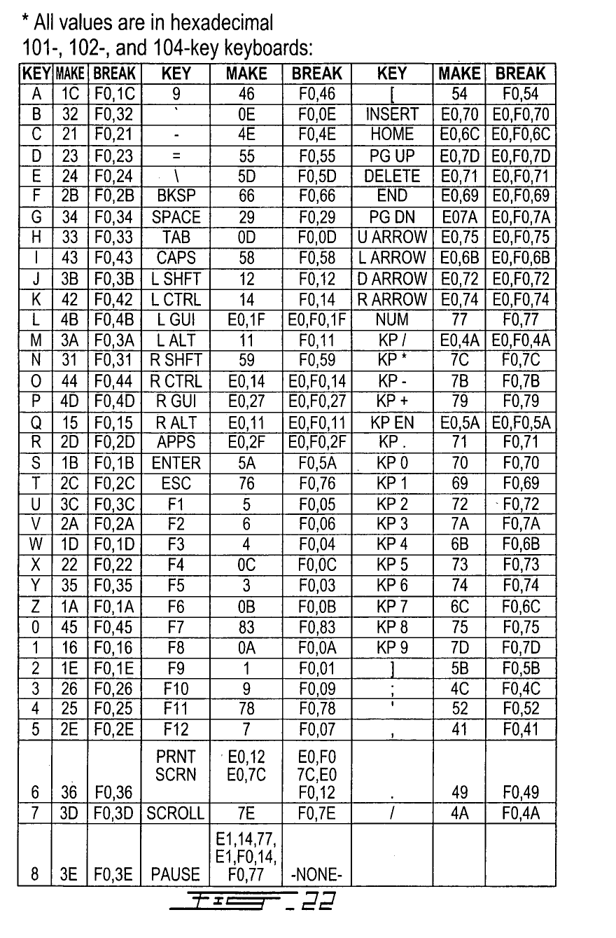

The keyboard's processor spends most of its time scanning, or monitoring, the matrix of keys. If it finds that any key is being pressed, released, or held down, the keyboard will send a packet of information known as a “scan code” to your computer. There are two different types of scan codes: “make codes” and “break codes”. A make code is sent when a key is pressed or held down. A break code is sent when a key is released. Every key is assigned its own unique make code and break code so the RRG 22 can determine exactly what happened to which key by looking at a single scan code. The set of make and break codes for every key comprises a “scan code set”. There are three standard scan code sets but the most frequently used one is summarized in FIG. 22.

Make Codes, Break Codes, and Typematic Repeat:

Whenever a key is pressed, the make code for that key is sent to the computer. A make code only represents a key on a keyboard, it does not represent the character printed on that key. This means that there is no defined relationship between a make code and an ASCII code. It's up to the RRG 22 to translate scan codes to characters or commands.

Although most of set two make codes are only one-byte wide, there are a handful of “extended keys” whose make codes are two or four bytes wide. These make codes can be identified by the fact that their first byte is E0h.

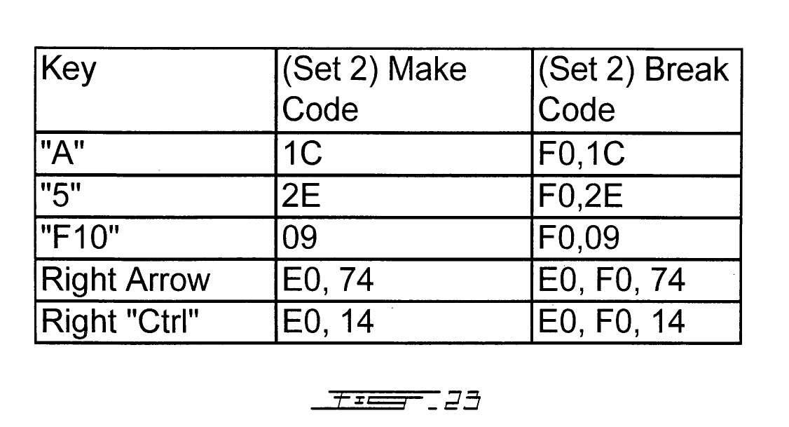

Just as a make code is sent to the computer whenever a key is pressed, a break code is sent whenever a key is released. In addition to every key having its own unique make code, they all have their own unique break code. Fortunately, however, one doesn't always have to use lookup tables to figure out a key's break code—certain relationships do exist between make codes and break codes. Most break codes are two bytes long where the first byte is F0h and the second byte is the make code for that key. Break codes for extended keys are usually three bytes long where the first two bytes are E0h, F0h, and the last byte is the last byte of that key's make code. As an example, a set of make codes and break codes for a few keys is shown in FIG. 23.

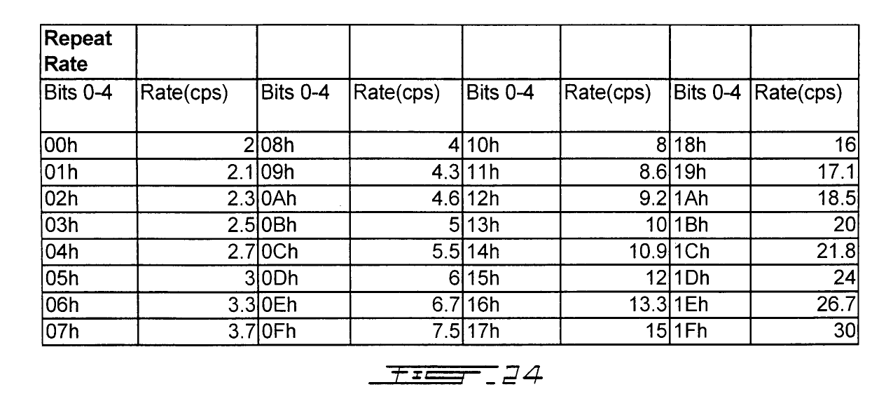

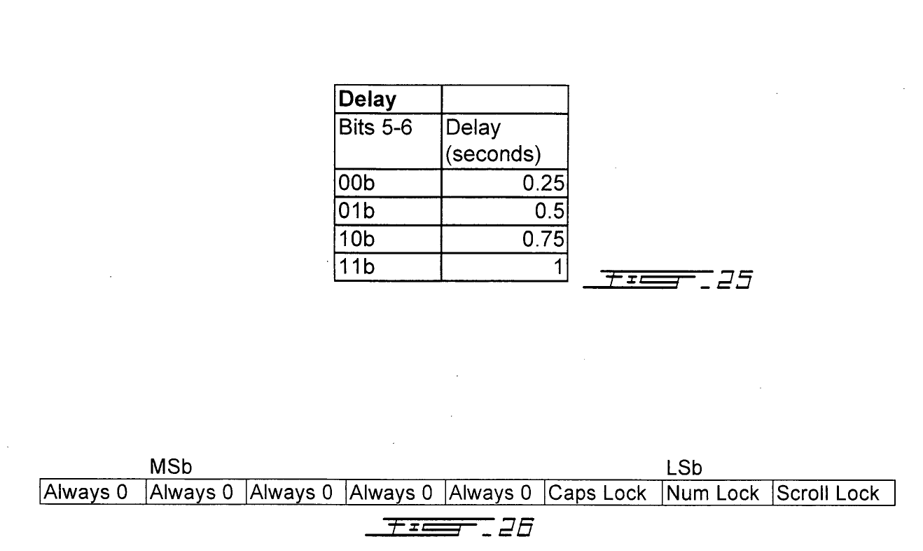

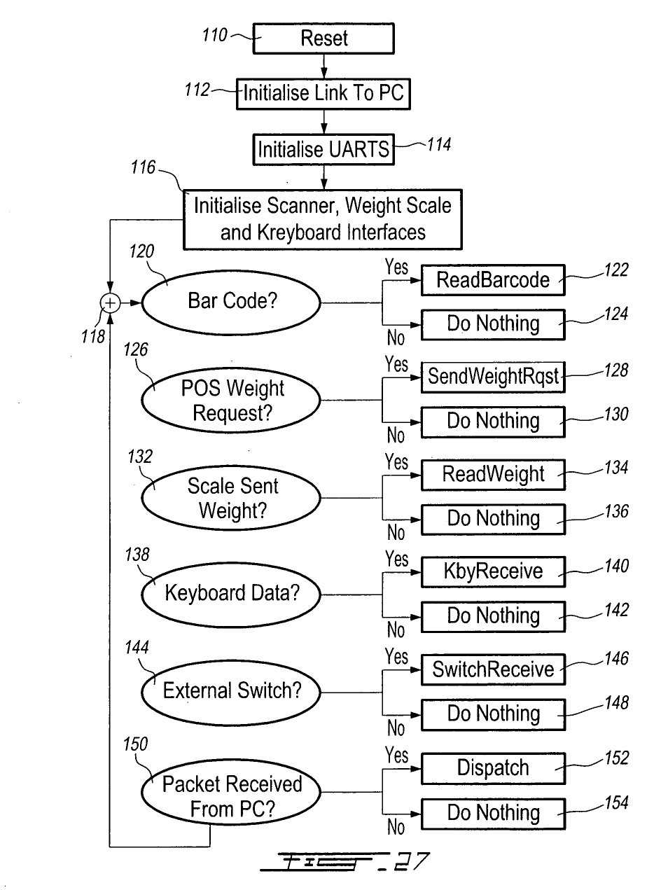

FIG. 24 shows the typematic repeat rate and FIG. 25 shows the typematic delay.

If one presses a key, its make code is sent to the computer. When one presses and holds down a key, that key becomes typematic, which means the keyboard will keep sending that key's make code until the key is released or another key is pressed. For example, a user opens a text editor and holds down the “A” key. When he first presses the key, the character “a” immediately appears on the screen. After a short delay, another “a” will appear followed by a whole stream of “a”'s until he releases the “A” key. There are two important parameters here: the typematic delay, which is the short delay between the first and second “a”, and the typematic rate, which is how many characters per second will appear on your screen after the typematic delay. The typematic delay can range from 0.25 seconds to 1.00 second and the typematic rate can range from 2.0 cps (characters per second) to 30.0 cps. One may change the typematic rate and delay using the “Set Typematic Rate/Delay” (0×F3) command.

Typematic data is not buffered within the keyboard. In the case where more than one key is held down, only the last key pressed becomes typematic. Typematic repeat then stops when that key is released, even though other keys may be held down.

Reset:

At power on or software reset, the keyboard performs a diagnostic self-test referred to as BAT (Basic Assurance Test) and loads the following default values:

Typematic delay: 500 ms.
Typematic rate: 10.9 cps.
Scan code set: 2.
Set all keys typematic/make/break codes.

When entering BAT, the keyboard enables its three LED indicators, and turns them off when BAT has completed. At this time, a BAT completion code of either 0×AA (BAT successful) or 0×FC (Error) is sent to the RRG 22. This BAT completion code must be sent 500-750 milliseconds after power on.

Many of the keyboards tested ignore their CLOCK and DATA lines until after the BAT completion code has been sent. Therefore, an “Inhibit” condition (CLOCK line low) may not prevent the keyboard from sending its BAT completion code.

Command Set:

Certain commands can be issued by the RRG to the keyboard. The keyboard clears its output buffer when it receives any command. If the keyboard receives an invalid command or argument, it must respond with “resend” (0×FE). The keyboard must not send any scan codes while processing a command. If the keyboard is waiting for an argument byte and it instead receives a command, it should discard the previous command and process this new one.

Below are the commands the RRG 22 may send to the keyboard:

0xFF (Reset) - Keyboard responds with “ack” (0xFA), then
enters “Reset” mode.
0xFE (Resend) - Keyboard responds by resending the last-sent
byte. The exception to this is if the last-sent byte was
“resend” (0xFE). If this is the case, the keyboard
resends the last non-0xFE byte. This command is used by the
RRG 22 to indicate an error in reception.

The next six commands can be issued when the keyboard is in any mode, but it only effects the behavior of the keyboard when in “mode 3” (i.e., set to scan code set 3.)

*0xFD (Set Key Type Make) - Disable break codes and typematic
repeat for specified keys. Keyboard responds with “ack”
(0xFA), then disables scanning (if enabled) and reads a
list of keys from the RRG 22. These keys are specified by
their set 3 make codes. Keyboard responds to each make code
with “ack”. RRG 22 terminates this list by sending an
invalid set 3 make code (e.g., a valid command.) The keyboard
then re-enables scanning (if previously disabled).
*0xFC (Set Key Type Make/Break) - Similar to previous command,
except this one only disables typematic repeat.
*0xFB (Set Key Type Typematic) - Similar to previous two,
except this one only disables break codes.
*0xFA (Set All Keys Typematic/Make/Break) - Keyboard
responds with “ack” (0xFA). Sets all keys to their
normal setting (generate scan codes on make, break, and
typematic repeat)
*0xF9 (Set All Keys Make) - Keyboard responds with
“ack” (0xFA). Similar to 0xFD, except applies
to all keys.
*0xF8 (Set All Keys Make/Break) - Keyboard responds with
“ack” (0xFA). Similar to 0xFC, except applies
to all keys.
*0xF7 (Set All Keys Typematic) - Keyboard responds with
“ack” (0xFA). Similar to 0xFB, except applies
to all keys.
0xF6 (Set Default) - Load default typematic rate/delay
(10.9 cps/500 ms), key types (all keys typematic/make/break),
and scan code set (2).
0xF5 (Disable) - Keyboard stops scanning, loads default
values (see “Set Default” command), and waits
further instructions.
0xF4 (Enable) - Re-enables keyboard after disabled using
previous command.
0xF3 (Set Typematic Rate/Delay) - RRG 22 follows this
command with one argument byte that defines the typematic
rate and delay as follows:
*0xF2 (Read ID) - The keyboard responds by sending a
two-byte device ID of 0xAB, 0x83. (0xAB is sent first,
followed by 0x83.)
*0xF0 (Set Scan Code Set) - Keyboard responds with
“ack”, then reads argument byte from the RRG
22. This argument byte may be 0x01, 0x02, or 0x03
to select scan code set 1, 2, or 3, respectively.
The keyboard responds to this argument byte with
“ack”. If the argument byte is 0x00, the
keyboard responds with “ack” followed by
the current scan code set.
0xEE (Echo) - The keyboard responds with “Echo”
(0xEE).
0xED (Set/Reset LEDs) - The RRG 22 follows this
command with one argument byte, that specifies the
state of the keyboard's Num Lock, Caps Lock, and Scroll
Lock LEDs. This argument byte is defined as follows:

FIG. 6 shows the Argument Byte Table “X”. In the Argument Byte, the following bits are defined:

“Scroll Lock” - Scroll Lock LED off(0)/on(1)
“Num Lock” - Num Lock LED off(0)/on(1)
“Caps Lock” - Caps Lock LED off(0)/on(1). Originally available in PS/2
keyboards only.

### DETAILED DESCRIPTION OF THE SOFTWARE

The function of each routine element of the DGD software will now be discussed.

FIG. 27 is a flow chart of the events and the flow of the main program loop. As stated earlier, the microcontroller polls every port constantly and waits for data to be present and then sends it to the RRG 22.

This is even more clearly illustrated in the following code from an example main loop of the program:

| | |
|---|---|
| 00035 | void main(void) |
| 00036 | { |
| 00037 | // pause |
| 00038 | Delay10KTCYx(255); // approx 400 ms |
| 00039 | Delay10KTCYx(255); // approx 400 ms |
| 00040 | |
| 00041 | RRGLink_init( ); |
| 00042 | uart_Init( ); |
| 00043 | |
| 00044 | uart_Set9600_8N1(SCANNER_DEV); |
| 00045 | uart_Set9600_8N1(SCANNER_RRG); |
| 00046 | uart_Set9600_7E1(SCALE_DEV); |
| 00047 | uart_Set9600_7E1(SCALE_RRG); |
| 00048 | |
| 00049 | uart_Set9600_8N1(SWITCH_POS); |
| 00050 | |
| 00051 | |
| 00052 | scanner_Init( ); |
| 00053 | weight_Init( ); |
| 00054 | keyb_Init( ); |
| 00055 | |
| 00056 | |
| 00057 | while(1) |
| 00058 | { |
| 00059 | scanner_ReadBarcode( ); |
| 00060 | |
| 00061 | weight_CheckRRGRequest( ); |
| 00062 | weight_ReadWeight( ); |
| 00063 | |
| 00064 | keyb_ReceiveFromKeyb( ); |
| 00065 | |
| 00066 | switch_ReceiveFromSwitch( ); |
| 00067 | |
| 00068 | if(RRGLink_rx( )) |
| 00069 | Dispatch( ); |
| 00070 | } |
| 00071 | |
| 00072 | |
| 00073 | } |

The functions scanner_ReadBarcode( ), weight_CheckRRGRequest( ), weight_ReadWeight( ), keyb_ReceiveFromKeyb( ), switch_ReceiveFromSwitch( ), RRGLink_rx( ) and Dispatch( ) will be explained individually.

scanner_ReadBarcode( ):

Read scanner serial port until CR/LF is received. When final LF is received, build and transmit a packet to the RRG 22 (with only the barcode data).

weight_CheckRRGRequest( ):

Check if the POS software has sent a readscale request (char 87 decimal). If so, re-inject the request to the scale. The RRG does not need to see the request, and since the POS software sometimes polls the scale, it would overload the RRG.

weight_ReadWeight( ):

Read data bytes from scale. Each received char is sent to the POS without processing. When a CR is received, a copy of the complete weight is send to the RRG (only if it is different compared to the last weight received).

keyb_ReceiveFromKeyb( ):

Sample clock line and fetch. Check keyboard for low data line that would signal data transmission. A 5 ms timeout to receive everything is used.

switch_ReceiveFromSwitch( ):

Check data from switch and send it to RRG only if the switch goes from 1 to 0.

RRGLink_rx( ):

Return true if a packet has been received and is ready to be processed by the application. If true is returned, access it via global rxPacket, and when done set the “ready” member to 0.

Dispatch( ):

Take the received packet from RRG and dispatch processing.

barcode inject command received from RRG −> send barcode to POS
weight request inject command received from RRG −> send request
to scale
weight request inject command received from RRG −> send weight
to POS
key data inject command −> send keyb data to POS
set switch pattern −> send switch pattern command to random
rebate generator switch

As will be understood, when data is received from the scale and a product code is received from the keyboard, the RRG determines that a fresh product was purchased by the client and can calculate and the purchase price using price tables provided by the store. Once the purchase price is determined, the random rebate generator can be triggered.

It should be noted that the present invention can be carried out as a method, can be embodied in a system, a computer readable medium or an electrical or electro-magnetical signal.

It will be understood that numerous modifications thereto will appear to those skilled in the art. Accordingly, the above description and accompanying drawings should be taken as illustrative of the invention and not in a limiting sense. It will further be understood that it is intended to cover any variations, uses, or adaptations of the invention following, in general, the principles of the invention and including such departures from the present disclosure as come within known or customary practice within the art to which the invention pertains and as may be applied to the essential features herein before set forth, and as follows in the scope of the appended claims.

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

1. A method for awarding an instant rebate comprising:
determining a price for each item of a purchase of at least one item made by a client;
selecting at least one item of said purchase using at least one of a nature of said item, said price determined, a price for a plurality of said at least one item and a total price for said purchase;
activating a random rebate generator using said at least one item selected to determine if an amount proportional to said price determined is to be awarded to said client;
calculating an altered price by reducing said price determined by said proportional amount if said proportional amount is to be awarded;
carrying out a payment of said altered price by said client.

2. The method as claimed in claim 1, wherein said item is a fresh product.

3. The method as claimed in claim 2, wherein said determining comprises obtaining a weight for said item, a product identification for said item and a price per weight corresponding to said product identification.

4. The method as claimed in claim 1, further comprising
said client confirming his participation in an attribution of the rebate by said random rebate generator.

5. The method as claimed in claim 1, wherein said determining, said selecting, said activating, said calculating and said carrying out are processed by a cash register.

6. The method as claimed in claim 1, wherein said proportional amount is said price determined.

7. The method as claimed in claim 1, wherein said proportional amount includes applicable sales taxes.

8. The method as claimed in claim 1, wherein said carrying out comprises:
said client paying said price using at least one of a credit and a debit card;
said random rebate generator being activated by a completion of a transaction with a card issuer of said at least one of a credit and a debit card;
said proportional amount being reimbursed to said client using said at least one of a credit and a debit card if it is to be awarded.

9. The method as claimed in claim 1, further comprising:
displaying said proportional amount.

10. The method as claimed in claim 1, wherein said activating comprises sending a signal to said random rebate generator.

11. The method as claimed in claim 1, wherein said activating comprises a cashier turning on said random rebate generator when said at least one item is selected.

12. A system for awarding an instant rebate, comprising:
a data gatherer for obtaining purchase information about a purchase of at least one item made by a client;
a price calculator for determining a price for each item of said purchase from said purchase information;
an item selector for selecting at least one item of said purchase using at least one of a nature of said item, said price determined, a price for a plurality of said at least one item and a total price for said purchase;
a random rebate generator triggered by said item selector to determine if an amount proportional to said item price for said at least one item chosen by said item selector is to be awarded to said client;
a rebate calculator reducing said price by said proportional amount to obtain an altered price if said proportional amount is determined to be awarded;
a payment receiver for carrying out a payment of said altered price.

13. The system as claimed in claim 12, wherein said item is a fresh product.

14. The system as claimed in claim 12, wherein said data gatherer obtains a weight for said item, a product identification for said item and a price per weight corresponding to said product identification.

15. The system as claimed in claim 12, further comprising
a client participation recorder for confirming that a client making said purchase wishes to participate in an attribution of the rebate by said random rebate generator.

16. The system as claimed in claim 15, wherein said client participation recorder comprises a button connected to said random rebate generator.

17. The system as claimed in claim 12, wherein said proportional amount is said item price.

18. The system as claimed in claim 12, wherein said proportional amount includes applicable sales taxes.

19. The system as claimed in claim 12, further comprising:
a transaction dialer for contacting a card issuer when a client making said purchase is paying said price using at least one of a credit and a debit card;
said random rebate generator being activated by said transaction dialer once a transaction with said card issuer is completed;
a reimbursement provider for contacting said card issuer to reimburse said proportional amount to said client using said at least one of a credit and a debit card if it is to be awarded.

20. The system as claimed in claim 12, further comprising a display for displaying said proportional amount.

21. The system as claimed in claim 12, wherein said price calculator is a cash register.

22. The system as claimed in claim 21, wherein said rebate calculator and said random rebate generator are provided in said cash register.
